(19) United States
(12) Patent Application Publication
(10) Pub. No.: US 2018/0058312 A1
(43) Pub. Date: Mar. 1, 2018

(54) Fuel Reformer Cooler

(71) Applicant: Caterpillar Inc., Peoria, IL (US)

(72) Inventors: Xinqiang Xu, Peoria, IL (US); Liang Wang, Peoria, IL (US); Xinyu Ge, Peoria, IL (US)

(73) Assignee: Caterpillar Inc., Peoria, IL (US)

(21) Appl. No.: 15/251,136

(22) Filed: Aug. 30, 2016

(51) Int. Cl. F02B 43/10; F28D 1/053; F28F 19/02; F02M 21/02; F02M 31/20; C01B 3/38

(52) U.S. Cl. CPC F02B 43/10; F28D 1/0535; F28F 19/02; F02M 21/0206; C01B 2203/84; C01B 3/38; C01B 2203/0233; C01B 2203/0883; C01B 2203/06; F02M 31/20

(57) ABSTRACT

A fuel reformer cooler for cooling a hydrogen-containing effluent released from a fuel reformer is disclosed. The fuel reformer cooler may comprise a heat transfer wall separating an effluent conduit from a coolant conduit and permitting heat transfer from the effluent in the effluent conduit to a coolant in the coolant conduit therethrough. The heat transfer wall may be formed from a base that includes a first surface facing the coolant conduit and a second surface facing the effluent conduit. The cooler may further comprise an anti-hydrogen embrittlement layer applied to the second surface of the base to shield the base from exposure to the effluent, and a plurality of symmetrical fins each extending through the anti-hydrogen embrittlement layer and contacting the second surface of the base. The plurality of symmetrical fins may project into the effluent conduit.

### TECHNICAL FIELD

The present disclosure generally relates to coolers for hydrogen-containing fluids and, more specifically, to coolers for cooling hydrogen-containing effluents released by fuel reformers.

### BACKGROUND

A fuel reformer is a device that transforms one type of fuel into another type of fuel. A common type of fuel reformer is a hydrogen fuel reformer which transforms fuel (e.g., natural gas, methane, liquid petroleum gas, etc.) into hydrogen. In a hydrogen fuel reformer, methane (CH₄) or natural gas may react with water and oxygen at high temperatures (e.g., about 700° C. to about 1100° C.) to produce hydrogen (H₂), carbon monoxide (CO), and other products. Fuel reformers may be used to produce hydrogen for fuel cell applications, or to provide a reducing atmosphere for catalyst regeneration in exhaust aftertreatment systems. In another use, fuel reforming may supply hydrogen gas to combustion chambers to facilitate and stabilize combustion under lean burn conditions (i.e., in an excess of air). In particular, because hydrogen ignites readily due to its high flame propagation speed, it may facilitate ignition of fuel and air in the combustion chamber.

Due to the high operating temperatures of hydrogen fuel reformers, the hydrogen-containing effluent gas leaving a hydrogen fuel reformer may be at high temperatures in a range of about 600° C. to about 800° C. or more. Prior to introduction of the reformed gas to an intake manifold and/or fuel admission valves for supporting lean burn combustion, the effluent gas should be sufficiently cooled to prevent shock issues in the combustion chamber. Ideally, the temperature of the effluent gas from a fuel reformer should be reduced to below about 120° C. prior to introduction into the combustion chamber. Coolers may be used for this purpose. However, it may be a technical challenge for a typical engine cooler or an industry cooler to withstand a hydrogen-rich environment due to hydrogen embrittlement.

Hydrogen embrittlement is caused by the diffusion of hydrogen atoms into a metal. The hydrogen atoms within the metal may recombine to form hydrogen molecules or other compounds that may create pressure within the metal. This pressure may increase to levels where the metal has reduced ductility, toughness, and tensile strength, such that the metal may eventually fracture or crack. Certain metals, such as steel, titanium, and aluminum alloys, are particularly vulnerable to hydrogen embrittlement compared to other types of metals and materials. As many coolers may include a steel framework, such coolers are vulnerable to hydrogen embrittlement. This problem may be further exacerbated by the high temperature of the effluent gas, as hydrogen diffusion into materials occurs more rapidly at higher temperatures. Hydrogen diffusion into the framework of the cooler may be further assisted by a hydrogen concentration gradient between the framework of the cooler and the effluent gas. Some coolers do not purge the gaseous mixture in the cooler at shutdown, such that hydrogen diffusion into the metal framework may occur at even lower temperatures due to significantly more hydrogen outside the metal than inside. Accordingly, coolers may be susceptible to early failure due to hydrogen embrittlement when used to cool hydrogen-containing effluent gas from fuel reformers.

U.S. Pat. No. 8,852,820 discloses a hydrogen fuel cell module having heat exchangers that heat fuel and air inlet streams, wherein the housing of the module is coated with an anti-hydrogen embrittlement material that protects the module from hydrogen embrittlement. While effective, the patent does relate to coolers for cooling effluent gas from fuel reformers. Thus, there is a need for improved cooler designs for cooling hydrogen-containing effluent gas from fuel reformers.

### SUMMARY

In accordance with one aspect of the present disclosure, a fuel reformer cooler for cooling a hydrogen-containing effluent released from a fuel reformer is disclosed. The fuel reformer cooler may comprise an effluent conduit configured to permit a flow of the effluent from an effluent inlet to an effluent outlet, a coolant conduit configured to permit a flow of a coolant from a coolant inlet to a coolant outlet, and a heat transfer wall separating the effluent conduit from the coolant conduit and permitting heat transfer from the effluent to the coolant therethrough. The heat transfer wall may be formed from a base that includes a first surface facing the coolant conduit and a second surface facing the effluent conduit. The fuel reformer cooler may further comprise an anti-hydrogen embrittlement layer applied to the second surface of the base to shield the base from exposure to the effluent, and a plurality of symmetrical fins each extending through the anti-hydrogen embrittlement layer and contacting the second surface of the base. The plurality of symmetrical fins may project into the effluent conduit.

In accordance with another aspect of the present disclosure, and engine system is disclosed. The engine system may comprise a combustion chamber configured to combust a mixture of fuel and air, an air intake system configured to supply the combustion chamber with the air, at least one fuel admission valve configured to supply the combustion chamber with the fuel, and a fuel reformer configured to transform the fuel into a hydrogen-containing effluent. The engine system may further comprise a fuel reformer cooler configured to cool the effluent released from the fuel reformer. The fuel reformer cooler may include a plurality of stacked heat transfer modules each having an effluent conduit, a coolant conduit, and at least one heat transfer wall separating the effluent conduit form the coolant conduit. The heat transfer wall may include a base facing the coolant conduit, an anti-hydrogen embrittlement layer facing the effluent conduit, and a plurality of symmetrical fins each contacting the base and extending through the anti-hydrogen embrittlement layer into the effluent conduit. The engine system may further comprise at least one delivery conduit configured to deliver the cooled effluent exiting the cooler to one of the air intake system and the fuel admission valve.

In accordance with another aspect of the present disclosure, a method for cooling a hydrogen-containing effluent released from a fuel reformer using a fuel reformer cooler is disclosed. The fuel reformer cooler may include a heat transfer wall separating an effluent conduit from a coolant conduit and including a base exposed to the coolant conduit and an anti-hydrogen embrittlement layer exposed to the effluent conduit. The method may comprise flowing a coolant through the coolant conduit and over the base, wherein the base is formed from steel and has a first surface facing the coolant conduit and a second surface facing the effluent conduit. The method may further comprise flowing the effluent through the effluent conduit and over the anti-hydrogen embrittlement layer, wherein the anti-hydrogen embrittlement layer is a nitride film applied to the second surface of the base. In addition, the method may further comprise transferring heat from the effluent in the effluent conduit to symmetrical fins extending from the second surface of the base into the effluent conduit, wherein the symmetrical fins are formed from copper. Furthermore, the method may comprise transferring heat from the symmetrical fins to the base, and dissipating heat from the base to the coolant in the coolant conduit.

These and other aspects and features of the present disclosure will be more readily understood when read in conjunction with the accompanying drawings.

### BRIEF DESCRIPTION OF THE DRAWINGS

FIG. 1 is a schematic representation of an engine system having a fuel reformer and a fuel reformer cooler for supplying a hydrogen-containing effluent to an engine, constructed in accordance with the present disclosure.

FIG. 2 is a sectional view of a portion of the engine of the engine system, constructed in accordance with the present disclosure.

FIG. 3 is a perspective view of the fuel reformer cooler shown in isolation, constructed in accordance with the present disclosure.

FIG. 4 is a cross-sectional view through the section 4-4 of FIG. 3, constructed in accordance with the present disclosure.

FIG. 5 is a perspective view of a coolant annulus of the fuel reformer cooler containing stacked effluent conduits, constructed in accordance with the present disclosure.

FIG. 6 is a side view of a heat transfer module of the fuel reformer cooler, constructed in accordance with the present disclosure.

FIG. 7 is an exploded view of detail 7 of FIG. 6, illustrating a heat transfer wall of the heat transfer module, constructed in accordance with the present disclosure.

FIG. 8 is a flowchart depicting a series of steps involved in cooling the hydrogen-containing effluent using the fuel reformer cooler, in accordance with a method of the present disclosure.

### DETAILED DESCRIPTION

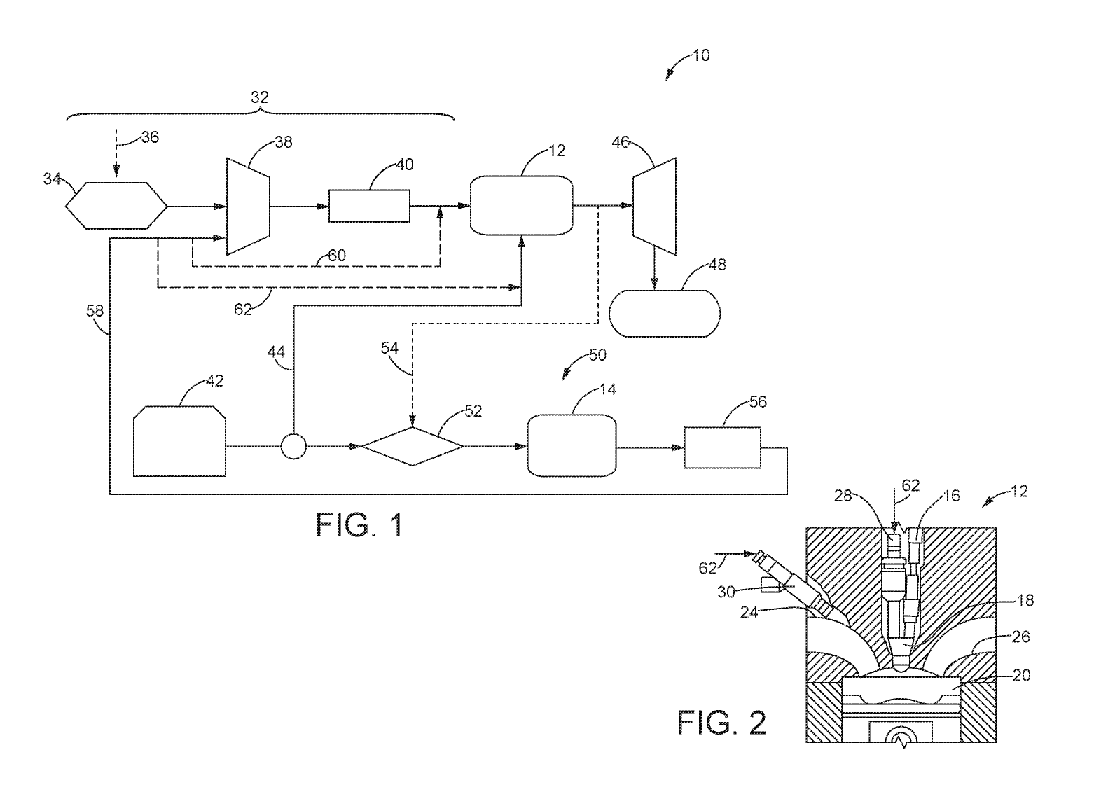

Referring now to the drawings, and with specific reference to FIG. 1, an engine system 10 is shown. The engine system 10 may provide power to a machine such as a mining truck, an off-road vehicle, a marine vehicle, earth-moving equipment, as well as other types of machines and equipment. In general, the engine system 10 may include an internal combustion engine 12 that combusts a fuel under lean conditions (i.e., in an excess of air) to provide mechanical energy to operate the machine, as well as a fuel reformer 14 that transforms a fuel into hydrogen (H₂) and other products (CO, CO₂, N₂, etc.) under elevated temperatures (e.g., about 700° C. to about 1100° C.) and in the presence of a catalyst as will be understood by those with ordinary skill in the art. The hydrogen produced by the fuel reformer 14 may be subsequently delivered to the engine 12 to support and stabilize lean burn combustion as described in further detail below.

As shown in FIG. 2, the engine 12 may be a spark-ignited engine that includes a spark plug 16 to initiate combustion in a pre-combustion chamber 18 that is in fluid communication with a main combustion chamber 20. The combustion in the pre-combustion chamber 18 may create jets that serve as an ignition source in the main combustion chamber 20. An intake manifold 24 may supply the main combustion chamber 20 with a mixture of fuel and air for combustion, and an exhaust manifold 26 may provide a passage to evacuate exhaust gases from the main combustion chamber 20. In addition, the engine 12 may have a first fuel admission valve 28 and a second fuel admission valve 30 for controlling a flow of fuel to the pre-combustion chamber 18 and the intake manifold 24, respectively. In other arrangements, the engine 12 may be a dual fuel engine in which combustion is initiated by ignition of a pilot fuel as will be understood by those with ordinary skill in the art.

Turning back to FIG. 1, the engine system 10 may include an air intake system 32 that provides air to the intake manifold 24. Included in the air intake system 32 may be an air cleaner 34 that purifies incoming ambient air 36, as well as a compressor 38 and an after cooler 40 downstream of the air cleaner 34. The compressor 38 may compress and increase the pressure of the ambient air, while the after cooler 40 may reduce the temperature of the air caused by compression prior to delivery to the engine 12 through the intake manifold 24. In addition, the engine system 10 may have one or more fuel sources 42 to supply one or more types of fuel (e.g., natural gas, methane, etc.) to the first and second fuel admission valves 28 and 30 via conduits 44. A turbine 46 may receive a flow of the exhaust gas via the exhaust manifold 26 and may extract mechanical work from the exhaust gas by expansion of the exhaust gas therethrough. Subsequently, the exhaust gases may be treated at one or more aftertreatment stations 48 to reduce the levels of NO,, and/or particulate matter in the exhaust gas prior to emission.

The fuel source 42 may also supply fuel (e.g., natural gas, methane, etc.) to a fuel reforming station 50 that includes the fuel reformer 14. For instance, the fuel source 42 may supply the same type of fuel (e.g., natural gas, methane, etc.) to the engine 12 for combustion and to the fuel reforming station 50 for production of hydrogen. In other arrangements, the engine 12 and the fuel reformer 14 may use different types of fuel derived from different fuel sources. At an upstream end of the fuel reforming station 50 may be a mixer 52 that mixes the fuel from the fuel source 42 with exhaust gas derived from the engine 12 via one or more conduits 54. Mixing of the fuel with the exhaust gas in this way increases the temperature of the fuel to enhance chemical transformation of the fuel at the downstream fuel reformer 14. Following mixing with the exhaust gas at the mixer 52, the fuel reformer 14 may transform the fuel to produce a high temperature (about 600° C. to about 800° C.) effluent containing hydrogen.

The hydrogen-containing effluent produced by the fuel reformer 14 may be subsequently cooled at a fuel reformer cooler 56 prior to delivery of the effluent to the engine 12. Specifically, the fuel reformer cooler 56 may lower the temperature of the effluent to a range between about 40° C. to about 120° C. In other arrangements, the effluent may be reduced to temperatures near or below ambient temperature at the cooler 56. Once cooled, the hydrogen-containing effluent may be supplied to the air intake system 32 or one or both of the fuel admission valves 28 and 30 for delivery to the pre-combustion chamber 18 and/or the main combustion chamber 20. For instance, the cooled effluent may be introduced upstream of the compressor 38 via one or more delivery conduits 58. Alternatively, or in combination with this, the cooled effluent gas may be delivered downstream of the after-cooler 40 through one or more delivery conduits 60 and/or into one or both of the first and second fuel admission valves 28 and 30 through one or more delivery conduits 62.

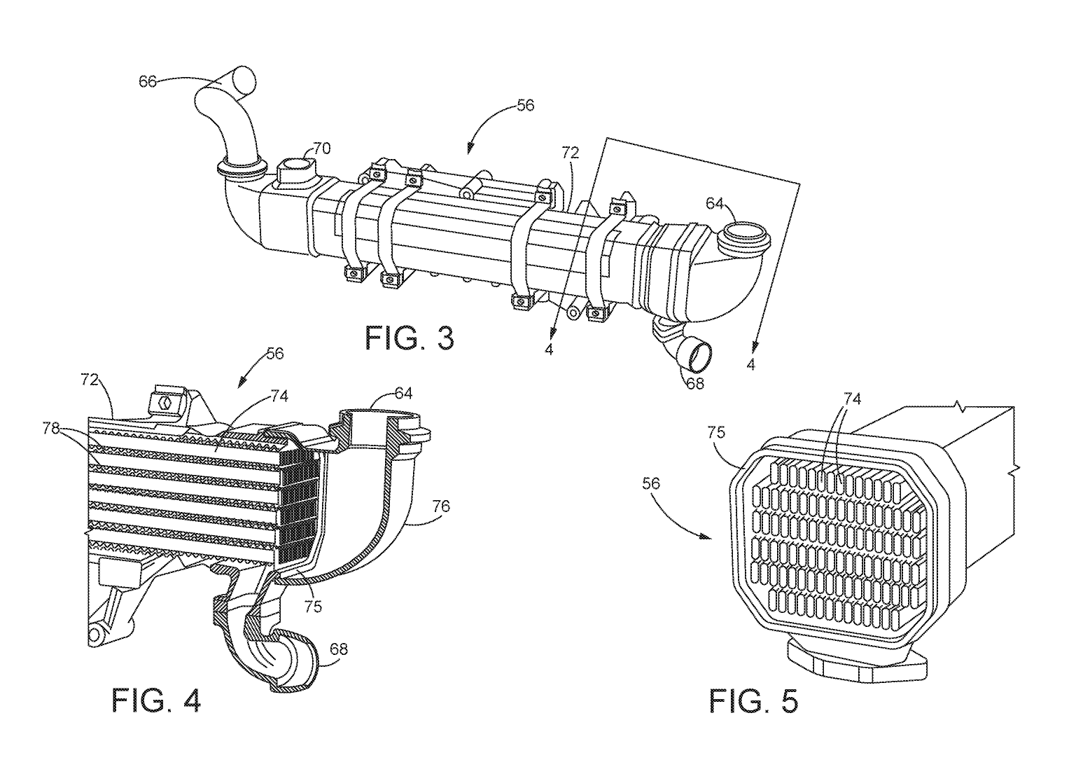

Turning now to FIGS. 3-5, the fuel reformer cooler 56 is shown in isolation. The fuel reformer cooler 56 may have an effluent inlet 64 through which the high temperature effluent from the fuel reformer 14 enters the cooler 56, as well as an effluent outlet 66 through which the cooled effluent exits the cooler 56 for delivery to the air intake system 32 and/or the fuel admission valves 28 and 30. In addition, the cooler 56 may have a coolant inlet 68 through which a coolant enters the cooler 56 for heat exchange with the effluent, and a coolant outlet 70 through which the coolant exits the cooler 56. The coolant may be water, although other types of coolants such as ethylene glycol or propylene glycol may also be used.

The cooler 56 may have a housing 72 containing one or more effluent conduits 74 through which the effluent flows from the inlet 64 to the outlet 66 while transferring heat to the coolant (see FIGS. 4-5). To handle high mass flow conditions, the cooler 56 may have a plurality of effluent conduits 74 stacked in repeating rows and columns, or other arrangements. The incoming effluent may be spread to the multiple effluent conduits 74 with a diffuser 76 at the inlet 64 (see FIG. 4). Surrounding the effluent conduits 74 in the housing 72 may be a coolant annulus 75 through which the coolant flows between the effluent conduits 74.

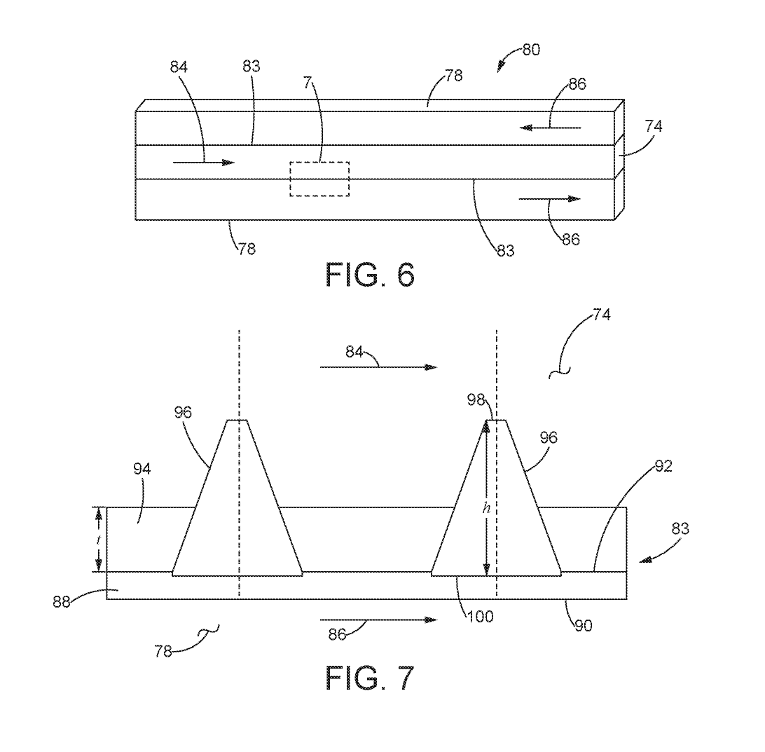

A single heat transfer module 80 of the cooler 56 is shown in FIG. 6. A plurality of the heat transfer modules 80 may be stacked or otherwise arranged to handle high mass flow rates of effluent (see FIGS. 4-5). However, under low mass flow rate conditions, the cooler 56 may have only one or a few heat transfer modules 80. Each heat transfer module 80 may include one of the effluent conduits 74 and one or more coolant conduits 78 through which coolant flows in heat exchange relation to the effluent conduit 74. Each heat transfer module 80 may have at least one heat transfer wall 83 separating the effluent conduit 74 from the coolant conduit 78 and permitting heat transfer from the effluent 84 to the coolant 86 therethrough. In one arrangement, the heat transfer module 80 may include two heat transfer walls 83 separating the effluent 84 from coolant 86 on two opposing sides of the effluent conduit 74, as shown in FIG. 6.

Turning now to FIG. 7, the heat transfer wall 83 of a heat transfer module 80 is shown in isolation. The heat transfer wall 83 may include a base 88 that is formed partly or entirely from a material, such as steel, that has a good thermal conductivity (about 50 Watts/meter·Kelvin (W/m·K)) but is susceptible to hydrogen embrittlement. The base 88 may include a first surface 90 facing the coolant conduit 78 so that it is exposed to the coolant 86 flowing through the coolant conduit 78, as well as a second surface 92 facing the effluent conduit 74. An anti-hydrogen embrittlement layer 94 may be applied or otherwise formed on the second surface 92 of the base 88 to shield the base 88 from attack by hydrogen in the effluent 84. For instance, the anti-hydrogen embrittlement layer 94 may be a coating or other surface modification of the base 88 that is resistant to hydrogen embrittlement. As used herein, an “anti-hydrogen embrittlement layer” is a layer of a material that has a hydrogen diffusion coefficient that is at least two orders of magnitude less than the hydrogen diffusion coefficient of iron at a given temperature (e.g., less than about 1.66×10⁻⁹ cm²/s at 100° C.). For instance, the anti-hydrogen embrittlement layer 94 may be a nitride film, such as a silicon nitride film, or it may be a layer or coating of a nickel-based alloy. Thus, the surface 92 of the base 88 facing the hydrogen-containing effluent 84 may be protected from hydrogen embrittlement by the anti-hydrogen embrittlement layer 94.

The anti-hydrogen embrittlement layer 94 may have a low thermal conductivity (about 30 Watts/meter·Kelvin (W/m·K) or less) and, therefore, may play a minor to negligible role in transferring heat from the effluent 84 to the coolant 86 across the wall 83. To compensate for reductions in heat transfer across the wall 83 caused by the insulating behavior of the anti-hydrogen embrittlement layer 94, the wall 83 may further include a plurality of heat-conducting fins 96 that extend from the second surface 92 of the base 88 and project into the effluent conduit 74. The fins 96 may extend through a thickness (t) of the anti-hydrogen embrittlement layer 94 to make direct contact with both the effluent gas 84 in the conduit 74 on one side and the base 88 on the other. As such, heat may be effectively transferred across the wall 83 from the effluent 84 to the coolant 86 through the fins 96 and the base 88 which have good to high thermal conductivity. In addition, the fins 96 may promote heat transfer by increasing the surface area of contact between the effluent 84 and highly conductive portions of the heat transfer wall 83, thereby compensating for the loss in conductive surface area caused by the insulating layer 94.

The fins 96 may be formed from a material having a high thermal conductivity of at least about 300 W/m·K or more. For instance, the fins 96 may be formed partly or entirely from copper. In addition, each of the fins 96 may have a height (h) extending from a top 98, that is exposed to the effluent 84, to a bottom 100, that is in contact with the base 88. The bottom 100 of each of the fins 96 may have a larger cross-sectional area than the top 98 to provide a large contact surface area between the fins 96 and the base 88, thereby promoting heat transfer therebetween. Each of the fins 96 may also have a symmetrical shape so that the fins 96 are resistant to mechanical stress under high pressures. In one arrangement, the fins 96 may have a conical shape as shown in FIG. 6. The conical shape of the fins 96 may provide a robust structure. In alternative designs, the fins 96 may have various other types of shapes such as rectangular, spherical, polygonal, or even asymmetrical shapes.

The anti-hydrogen embrittlement layer 94 may have a pliable consistency such that the fins 96 may be press fit or pushed through the layer 94 for installation, with the anti-embrittlement layer 94 holding the fins 96 in place on the wall 83. More specifically, the fins 96 may be installed on the heat transfer wall 83 by inserting the fins 96 through the anti-hydrogen embrittlement layer 94 until the bottoms 100 of the fins 96 contact the second surface 92 of the base 88, without a chemical bond or mechanical connection between the fins 96 and the base 88. Thus, the fins 96 may be readily removed and replaced as needed when damaged to increase the useful life of the cooler 56. The cooler 56 may also remanufactured at the end of the useful life. In addition, to ensure that the fins 96 are retained in place on the wall 83 while allowing sufficient contact between the fins 96 and the effluent 84, the thickness (t) of the anti-hydrogen embrittlement layer 94 may be about one-third the height (h) of the fins 96.

### INDUSTRIAL APPLICABILITY

In general, the teachings of the present disclosure may find applicability in many industries including, but not limited to, industries using coolers for hydrogen-containing fluids. As disclosed herein, the fuel reformer cooler design may be used to supply hydrogen to internal combustion engines to support lean burn combustion in various types of machines, such as mining trucks, off-road vehicles, marine vehicles, and earth-moving equipment. However, the cooler configuration disclosed herein may also be applicable to any type of cooler that cools a hydrogen-enriched or hydrogen-containing fluid.

The cooler disclosed herein includes a heat transfer wall having an anti-hydrogen embrittlement layer applied to the effluent side of a base formed from a material that is susceptible to hydrogen embrittlement. The anti-hydrogen embrittlement layer effectively shields the base material from the hydrogen-containing effluent, thereby preventing hydrogen embrittlement at the base framework of the cooler and extending the useful life of the cooler. As the anti-hydrogen embrittlement layer may weakly participate in heat transfer due to its insulating properties, fins with high thermal conductivity may be inserted through the anti-hydrogen embrittlement layer on the effluent side of the wall to promote heat transfer from the hot effluent to the base. Namely, the fins may form a direct contact with the base to allow heat conduction from the fins to the base. The portion of the fins that contacts the base may have a larger cross-sectional area to further promote heat transfer to the base. All other surfaces of the base which are exposed to the effluent may be covered by the anti-hydrogen embrittlement layer to prevent hydrogen diffusion into the base.

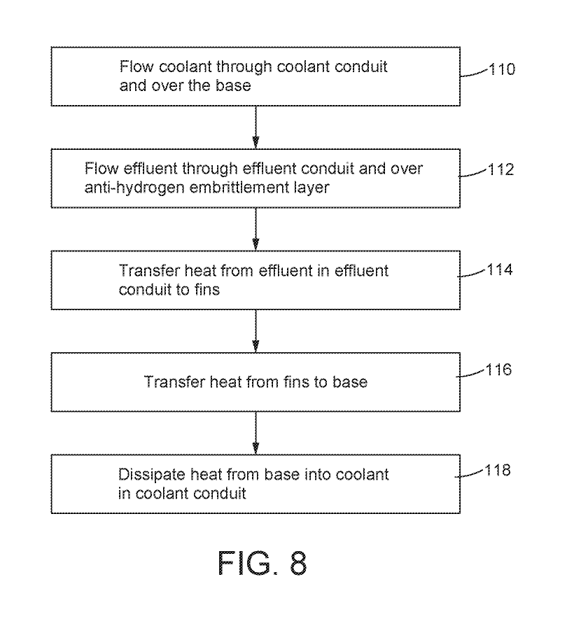

A series of steps that may be involved in cooling the hydrogen-containing effluent 84 using the fuel reformer cooler 56 are depicted in FIG. 8. At a block 110, the coolant 86 may be flowed through the coolant conduit 78 and over the base 88. Likewise, at a block 112, the hydrogen-containing effluent 84 may be flowed through the effluent conduit 74 and over the anti-hydrogen embrittlement layer 94, with the anti-hydrogen embrittlement layer 94 protecting the base 88 from hydrogen attack. It will be understood that the blocks 110 and 112 may be carried out in any order or simultaneously. The temperature difference between the hot effluent 84 and the fins 96 in the effluent conduit 74 may cause heat transfer from the effluent 84 to the fins 96 by convection and conduction according to a next block 114. The heat captured by the fins 96 may be transferred to the base 88 by conduction via the direct contact between the fins 96 and the base 88 according to a next block 116. At the coolant side of the heat transfer wall 83, the heat captured by the base 88 may be dissipated into the coolant 86 in the coolant conduit 78 according to a block 118. Thus, thermal gradients created across the heat transfer wall 83 due to the large temperature difference between the hot effluent on one side and the lower temperature coolant on the other side are effectively mitigated by heat transfer across the wall. Such mitigation of the thermal gradient across the heat transfer wall 83 may enhance the useful life of the cooler by reducing thermal stress on the cooler.

It is expected that the technology disclosed herein may find wide industrial applicability in a wide range of areas such as, but not limited to, lean burn engines, exhaust aftertreatment systems, and hydrogen fuel cell applications.

What is claimed is:

1. A fuel reformer cooler, comprising:
an effluent conduit configured to permit a flow of a hydrogen-containing effluent released from a fuel reformer from an effluent inlet to an effluent outlet;
a coolant conduit configured to permit a flow of a coolant from a coolant inlet to a coolant outlet;
a heat transfer wall separating the effluent conduit from the coolant conduit and permitting heat transfer from the effluent to the coolant therethrough, the heat transfer wall being formed from a base that includes a first surface facing the coolant conduit and a second surface facing the effluent conduit;
an anti-hydrogen embrittlement layer applied to the second surface of the base; and
a plurality of symmetrical fins each extending through the anti-hydrogen embrittlement layer and contacting the second surface of the base, the plurality of symmetrical fins projecting into the effluent conduit.

2. The fuel reformer cooler of claim 1, wherein the symmetrical fins are formed from a material having a thermal conductivity of at least about 300 Watts/meter·Kelvin (W/m·K).

3. The fuel reformer cooler of claim 2, wherein the symmetrical fins are at least partly formed from copper.

4. The fuel reformer cooler of claim 3, wherein the symmetrical fins are formed entirely from copper.

5. The fuel reformer cooler of claim 3, wherein the anti-hydrogen embrittlement layer is a nitride film.

6. The fuel reformer cooler of claim 3, wherein the anti-hydrogen embrittlement layer is composed of a nickel-based alloy.

7. The fuel reformer cooler of claim 3, wherein each of the symmetrical fins include a height extending from a top to a bottom, wherein the top projects into the effluent conduit and the bottom contacts the base, and wherein the top has a smaller cross-sectional area than the bottom.

8. The fuel reformer cooler of claim 7, wherein each of the symmetrical fins have a conical shape.

9. The fuel reformer cooler of claim 8, wherein the symmetrical fins are retained on the heat transfer wall by insertion into the anti-hydrogen embrittlement layer.

10. The fuel reformer cooler of claim 8, wherein the symmetrical fins are press fit into the anti-hydrogen embrittlement layer.

11. The fuel reformer cooler of claim 9, wherein the anti-hydrogen embrittlement layer has a thickness that is about one-third of the height of the symmetrical fins.

12. The fuel reformer cooler of claim 9, wherein the base is formed from steel.

13. An engine, comprising:
a combustion chamber configured to combust a mixture of air and fuel;
an air intake system configured to supply the combustion chamber with the air;
at least one fuel admission valve configured to supply the combustion chamber with the fuel;
a fuel reformer configured to transform the fuel into a hydrogen-containing effluent;
a fuel reformer cooler configured to cool the effluent released from the fuel reformer, the cooler including a plurality of stacked heat transfer modules each having an effluent conduit, a coolant conduit, and at least one heat transfer wall separating the effluent conduit from the coolant conduit, the heat transfer wall including a base facing the coolant conduit and an anti-hydrogen embrittlement layer facing the effluent conduit, the heat transfer wall further including a plurality of symmetrical fins contacting the base and extending through the anti-hydrogen embrittlement layer into the effluent conduit; and
at least one delivery conduit configured to deliver the cooled effluent exiting the cooler to one of the air intake system and the fuel admission valve.

14. The engine of claim 13, wherein the base of the heat transfer wall includes a first surface directed toward the coolant conduit and a second surface directed toward the effluent conduit, and wherein the anti-hydrogen embrittlement layer is applied on the second surface of the base and shields the base from the effluent.

15. The engine of claim 14, wherein the symmetrical fins are formed from a material having a thermal conductivity of at least about 300 Watts/meter·Kelvin (W/m·K).

16. The engine of claim 15, wherein the symmetrical fins are formed from copper.

17. The engine of claim 16, wherein the anti-hydrogen embrittlement layer is a nitride film.

18. The engine of claim 16, wherein the anti-hydrogen embrittlement layer is composed of a nickel-based alloy.

19. The engine of claim 17, wherein each of the symmetrical fins have a conical shape with a top having a smaller cross-sectional area than a bottom, and wherein the top of each of the fins projects into the effluent conduit and the bottom of each of the fins contacts the base.

20. A method for cooling a hydrogen-containing effluent released from a fuel reformer using a fuel reformer cooler, the fuel reformer cooler including a heat transfer wall separating an effluent conduit from a coolant conduit and including a base exposed to the coolant conduit and an anti-hydrogen embrittlement layer exposed to the effluent conduit, comprising:
flowing a coolant through the coolant conduit and over the base, the base being formed from steel and having a first surface facing the coolant conduit and a second surface facing the effluent conduit;
flowing the effluent through the effluent conduit and over the anti-hydrogen embrittlement layer, the anti-hydrogen embrittlement layer being a nitride film applied to the second surface of the base;
transferring heat from the effluent in the effluent conduit to symmetrical fins extending from the second surface of the base into effluent conduit, the symmetrical fins being formed from copper;
transferring heat from the symmetrical fins to the base; and
dissipating heat from the base to the coolant in the coolant conduit.
